(19) United States
(12) Patent Application Publication
(10) Pub. No.: US 2014/0354926 A1
(43) Pub. Date: Dec. 4, 2014

(54) DISPLAY APPARATUS

(71) Applicant: Samsung Display Co., Ltd., Yongin-City (KR)

(72) Inventors: Eun-Kil PARK, Yongin-City (KR); Seungho YANG, Yongin-City (KR); Wan-Soon IM, Yongin-City (KR)

(73) Assignee: SAMSUNG DISPLAY CO., LTD., Yongin-City (KR)

(21) Appl. No.: 14/284,523

(22) Filed: May 22, 2014

(30) Foreign Application Priority Data
May 30, 2013 (KR) 10-2013-0061645

(51) Int. Cl. G02F 1/1343; G02F 1/1337; G02F 1/1339; G02F 1/1335

(52) U.S. Cl. CPC G02F 1/134336; G02F 1/133512; G02F 1/1337; G02F 1/13394; G02F 2001/13398
USPC 349/110; 349/123

(57) ABSTRACT

A display apparatus includes a first substrate including a first base substrate and pixel electrodes on the first base substrate, the pixel electrodes including a plurality of fine slits, a second substrate including a second base substrate facing the first base substrate, the second base substrate including a reference electrode and being coupled to the first base substrate, a structure part including a step portion and extending from the second base substrate toward the first base substrate, the structure part being in a boundary area between two adjacent pixel electrodes and being configured to block a fringe field in the boundary area, and a liquid crystal layer between the pixel electrodes and the reference electrode and including liquid crystal molecules, an alignment of the liquid crystal molecules in an area adjacent to the structure part being controlled by the step portion of the structure part.

### CROSS-REFERENCE TO RELATED APPLICATION

Korean Patent Application No. 10-2013-0061645, filed on May 30, 2013, in the Korean Intellectual Property Office, and entitled: “Display Apparatus,” is incorporated by reference herein in its entirety.

### BACKGROUND

1. Field

The present disclosure relates to a display apparatus. More particularly, the present disclosure relates to a display apparatus capable of preventing a defect in texture and improving an aperture ratio.

2. Description of the Related Art

In general, a liquid crystal display includes two transparent substrates and a liquid crystal layer disposed between the two substrates. The liquid crystal display drives the liquid crystal layer to control light transmittance in each pixel, thereby displaying a desired image.

In a vertical alignment mode among various operation modes of the liquid crystal display, liquid crystal molecules are vertically aligned when an electric field is generated between the two substrates to transmit light, and thus the image is displayed. According to a patterned vertical alignment mode of the vertical alignment mode liquid crystal display, a pixel electrode and a common electrode are patterned to form liquid crystal domains that align the liquid crystal molecules in different directions, so that a viewing angle of the liquid crystal display is improved.

### SUMMARY

The present disclosure provides a display apparatus capable of preventing a defect in texture and improving an aperture ratio when a slit is formed in a pixel electrode.

Embodiments provide a display apparatus, including a first substrate including a first base substrate and pixel electrodes on the first base substrate, the pixel electrodes including a plurality of fine slits, a second substrate including a second base substrate facing the first base substrate, the second base substrate including a reference electrode and being coupled to the first base substrate, a structure part including a step portion and extending from the second base substrate toward the first base substrate, the structure part being in a boundary area between two adjacent pixel electrodes and being configured to block a fringe field in the boundary area, and a liquid crystal layer between the pixel electrodes and the reference electrode and including liquid crystal molecules, an alignment of the liquid crystal molecules in an area adjacent to the structure part being controlled by the step portion of the structure part.

Each pixel electrode may include a reference trunk portion dividing the pixel electrode into a first domain area and a second domain area.

The fine slits in each pixel electrode may include first fine slits in the first domain area, the first fine slits being inclined in a first direction with respect to the reference trunk, and second fine slits in the second domain area, the second fine slits being inclined in a second direction with respect to the reference trunk portion, the second fine slits being symmetrical with the first fine slits with respect to the reference trunk portions.

The structure part may have a length in a direction substantially perpendicular to the reference trunk portion, and has a width in a direction opposite to a vector sum of the first and second directions with respect to a center line of the pixel electrode.

When the first and second fine slits are respectively extended in the first and second directions in the pixel arranged in n row by n column (n is natural number equal to or greater than 1), the first and second fine slits may be respectively extended in a third direction opposite to the second direction and a fourth direction opposite to the first direction in the pixel arranged in n row by (n+1) column and the pixel arranged in (n+1) row by n column.

The structure part may be alternately disposed at left and right sides along a column direction with respect to the center line of the pixel electrode and disposed in a row direction every two pixels.

The structure part may partially overlap the pixel electrode when viewed in a plan view.

The structure part may have an oval shape or a rectangular shape when viewed in a plan view.

The structure part may include a spacer, the spacer being configured to maintain a constant distance between the first base substrate and the second base substrate.

The spacer may have a height from about 1.5 micrometers to about 2.5 micrometers.

A sidewall of the spacer may be tapered at an angle from about 40 degrees to about 90 degrees, the angle being defined relative to a surface of the second base substrate.

The spacer may partially overlap the pixel electrode when viewed in a plan view.

The structure part may further include a black matrix between the spacer and the second base substrate, the black matrix including a light blocking material.

The black matrix may have a thickness of about 0.9 micrometers to about 1.5 micrometers.

A sidewall of the black matrix may be tapered at an angle from about 40 degrees to about 90 degrees, the angle being defined relative to a surface of the second base substrate.

The black matrix may partially overlap the pixel electrode when viewed in a plan view.

The structure part may further include an overcoating layer between the black matrix and the spacer.

The structure part may further include a black matrix disposed on the second base substrate, the black matrix including a light blocking material.

The display apparatus may further include a first alignment layer on the first substrate, and a second alignment layer on the second substrate and face the first alignment layer, the liquid crystal layer being between the first and second alignment layers.

The display apparatus may further include a first light-curable layer on the first alignment layer, the first light-curable layer being configured to pre-tilt liquid crystal molecules adjacent to the pixel electrode, and a second light-curable layer on the second alignment layer, the second light-curable layer being configured to pre-tilt liquid crystal molecules adjacent to the reference electrode.

### BRIEF DESCRIPTION OF THE DRAWINGS

Features will become apparent to those of ordinary skill in the art by describing in detail exemplary embodiments with reference to the attached drawings, in which:

FIG. 1 illustrates a block diagram of a liquid crystal display according to an exemplary embodiment of the present disclosure;

FIG. 2 illustrates a plan view of a pixel in FIG. 1;

FIG. 3 illustrates a plan view showing a position relation between a pixel electrode and a spacer shown in FIG. 2;

FIG. 4 illustrates a cross-sectional view taken along line I-I′ shown in FIG. 3;

FIG. 5 illustrates a cross-sectional view showing a pixel according to another exemplary embodiment of the present disclosure;

FIG. 6 illustrates a cross-sectional view showing an alignment state of liquid crystal molecules in a sidewall portion of the spacer shown in FIG. 5;

FIG. 7 illustrates a view of a simulation result related to a light transmittance when a pixel is driven;

FIG. 8 illustrates a plan view showing a pixel and a spacer according to another exemplary embodiment of the present disclosure;

FIG. 9 illustrates a plan view showing a position relation between a spacer and a pixel according to another exemplary embodiment of the present disclosure;

FIG. 10 illustrates a cross-sectional view taken along line II-II′ shown in FIG. 9;

FIG. 11 illustrates a plan view showing a spacer according to another exemplary embodiment of the present disclosure;

FIG. 12 illustrates a graph showing transmittance of a pixel as a function of driving voltage;

FIG. 13 illustrates a graph showing transmittance of a pixel when the driving voltage is about 8 volts;

FIG. 14 illustrates a plan view showing a position relation between a spacer and pixels arranged in three columns by four rows according to an exemplary embodiment of the present disclosure;

FIG. 15 illustrates a plan view showing a position relation between a spacer and pixels arranged in four columns by four rows according to another exemplary embodiment of the present disclosure;

FIG. 16 illustrates a cross-sectional view showing a pixel according to another exemplary embodiment of the present disclosure;

FIG. 17 illustrates a cross-sectional view showing a pixel according to another exemplary embodiment of the present disclosure;

FIG. 18 illustrates a cross-sectional view showing a pixel according to another exemplary embodiment of the present disclosure; and

FIG. 19 illustrates a cross-sectional view showing a pixel according to another exemplary embodiment of the present disclosure.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when an element or layer is referred to as being “on”, “connected to” or “coupled to” another element or layer, it can be directly on, connected or coupled to the other element or layer, or intervening elements or layers may be present. In contrast, when an element is referred to as being “directly on,” “directly connected to,” or “directly coupled to” another element or layer, there are no intervening elements or layers present. Like reference numerals refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the embodiments.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, embodiments will be explained in detail with reference to the accompanying drawings.

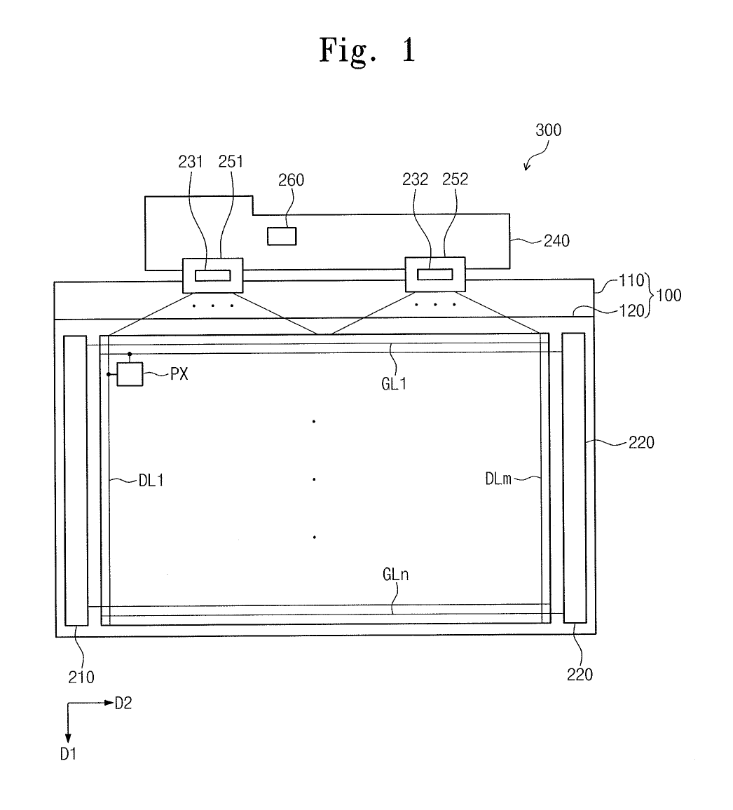

FIG. 1 illustrates a block diagram of a display apparatus according to an exemplary embodiment of the present disclosure. Referring to FIG. 1, a display apparatus 300 may include a timing controller 260, a data driver, a gate driver, and a display panel 100.

The display panel 100 may include a plurality of signal lines and a plurality of pixel columns. Each of the pixel columns includes a plurality of pixels PX arranged in a column direction D1 (hereinafter, referred to as a first direction). As an example, the pixels PX included in each pixel column may be sequentially driven along the first direction D1. In addition, the pixel columns are arranged in a row direction D2 (hereinafter, referred to as a second direction). Here, the pixels PX arranged in a same row may be substantially simultaneously driven.

The display panel 100 further includes red, green, and blue color pixels. The red, green, and blue color pixels may be sequentially arranged in the first direction D1 and the red, green, and blue color pixels, i.e., three color pixels, may be repeatedly arranged. In addition, the color pixels arranged in the same row may display the same color. For example, the color pixels arranged on the display panel 100 may have white, yellow, cyan, and magenta colors in addition to the red, green, and blue colors.

The display panel 100 may include two substrates 110 and 120 facing each other (hereinafter, referred to as first and second substrates), and the pixels PX may be disposed on one substrate, e.g., the first substrate 110, of the two substrates 110 and 120. When the pixels PX are disposed on the first substrate 110, the color pixels are disposed on the first substrate 110 together with the pixels PX or disposed on the second substrate 120 to be separated from the pixels PX.

Although not shown in figures, the display panel 100 may further include a liquid crystal layer (not shown) interposed between the first substrate 110 and the second substrate 120, which face each other.

The signal lines include a plurality of gate lines GL1 to GLn applied with gate signals and a plurality of data lines DL1 to DLm applied with data voltages. The gate lines GL1 to GLn are extended in the second direction D2 and arranged to be substantially in parallel to each other. The data lines DL1 to DLm are extended in the first direction D1 and arranged to be substantially in parallel to each other.

Each of the pixels PX is connected to the gate driver and the data driver. In the present exemplary embodiment, the gate driver includes a first amorphous silicon gate driver 210 (hereinafter, referred to as a first ASG) and a second amorphous silicon gate driver 220 (hereinafter, referred to as a second ASG). The first ASG 210 and the second ASG 220 may be formed on the first substrate 110 through a thin film process.

The first and second ASGs 210 and 220 may be respectively disposed at left and right sides of the first substrate 110. In addition, the first ASG 210 may drive odd-numbered gate lines of the gate lines GL1 to GLn, and the second ASG 220 may drive even-numbered gate lines of the gate lines GL1 to GLn.

The data driver may include a first driving chip 231 and a second driving chip 232, but the number of the driving chips of the data driver should not be limited thereto or thereby. The first and second driving chips 231 and 232 may be mounted on first and second flexible printed circuits (FPCs) 251 and 252 attached to the display panel 100, respectively. According to another embodiment, however, the first and second driving chips 231 and 232 may be mounted on the display panel 100.

The display panel 100 is electrically connected to a printed circuit board 240 through the first and second FPCs 251 and 252. The timing controller 260 may be mounted on the printed circuit board 240 in a chip form.

The timing controller 260 receives image signals and control signals from an external source (not shown). The timing controller 260 converts a data format of the image signals to a data format appropriate to an interface between the timing controller 260 and the data driver and provides the converted image signals to the data driver. In addition, the timing controller 260 applies a data control signal, e.g., an output start signal, a horizontal start signal, etc., to the data driver and applies a gate control signal, e.g., a vertical start signal, a vertical clock signal, a vertical clock bar signal, etc., to the gate driver.

The gate driver sequentially outputs gate signals in response to the gate control signal from the timing controller 260. Accordingly, the pixels PX are sequentially scanned by the gate signals in the unit of row.

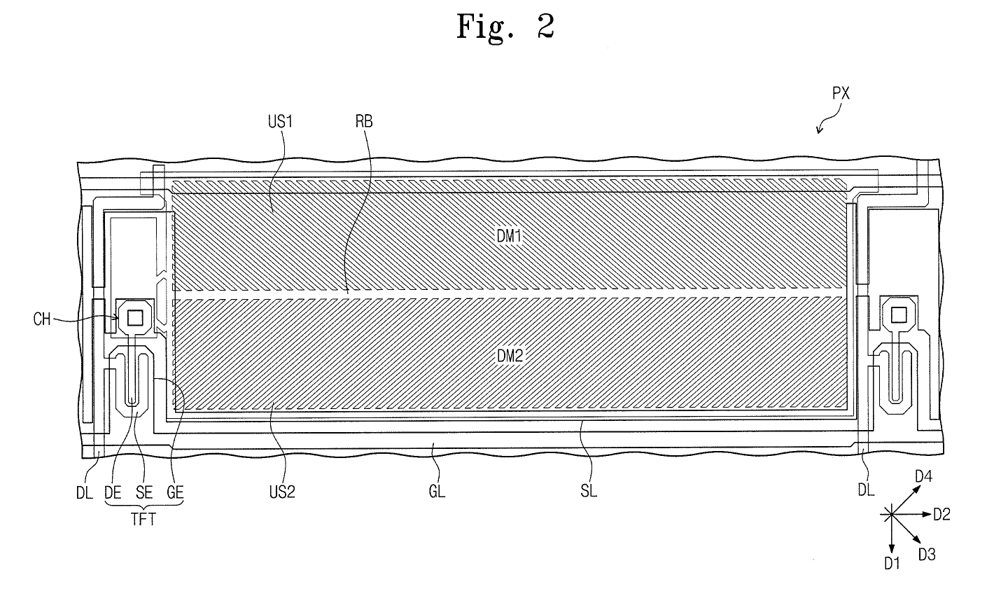

The data driver converts the image signals to the data voltages in response to the data control signal from the timing controller 260 and outputs the data voltages. The output data voltages are applied to the display panel 100. Thus, each pixel PX is turned on by a corresponding gate signal of the gate signals, and the turned-on pixel PX receives a corresponding data voltage of the data voltages from the data driver, thereby displaying the image with a desired gray-scale level. In the present exemplary embodiment, the pixels PX have the same structure and function, and thus only one pixel will be described in detail with reference to FIG. 2.

FIG. 2 illustrates a plan view of the pixel PX. Referring to FIG. 2, the first substrate 110 may include a gate line GL, a data line DL, and a storage line SL, and the pixel PX may be disposed in an area defined by the gate line GL, the data line DL, and the storage line SL. The pixel PX may include a thin film transistor TFT and a pixel electrode PE.

The gate line GL is extended in the second direction D2, and the data line DL is extended in the first direction D1. The gate line GL is insulated from the data line DL while crossing the data line DL. The thin film transistor TFT includes a gate electrode GE branched from the gate line GL, a source electrode SE branched from the data line DL, and a drain electrode DE spaced apart from the source electrode SE by a predetermined distance.

The pixel electrode PE is electrically connected to the drain electrode DE of the thin film transistor TFT. The thin film transistor TFT is covered by a protective layer (not shown) or an insulating layer (not shown), and the pixel electrode PE is electrically connected to the drain electrode DE through a contact hole CH formed through the protective layer or the insulating layer.

As an example, when assuming that an area that transmits the light to display the image in each pixel is referred to as a pixel area, the pixel area has a rectangular shape elongated in the second direction D2. Roughly, a width in the second direction D2 of the pixel electrode PE is three times greater than a width in the first direction D1 of the pixel electrode PE.

The pixel electrode PE includes a reference trunk portion RB that divides the pixel area into two areas to define first and second domain areas DM1 and DM2. The reference trunk portion RB is extended in the second direction D2 to divide the pixel area into two areas arranged, e.g., adjacent to each other, in the first direction D1.

The pixel electrode PE includes a plurality of fine slits formed therethrough. In detail, first fine slits US1 are formed in the first domain area DM1 to be inclined in a third direction D3 with respect to the reference trunk portion RB, and second fine slits US2 are formed in the second domain area DM2 to be inclined in a fourth direction D4 with respect to the reference trunk portion RB. The first fine slits US1 are symmetrical with the second fine slits US2 with respect to the reference trunk portion RB.

The liquid crystal molecules are arranged to be inclined along a longitudinal direction of the first fine slits US1 in the first domain area DM1, and the liquid crystal molecules are arranged to be inclined along a longitudinal direction of the second fine slits US2 in the second domain area DM2. That is, the liquid crystal molecules of the liquid crystal layer 130 are tilted in different directions by the first and second fine slits US1 and US2 according to the first and second domains DM1 and DM2.

Meanwhile, the storage line SL receives a common voltage and is disposed on the first substrate 110 to overlap with an edge of the pixel electrode PE. A storage capacitor is formed in the area in which the storage line SL is overlapped with the pixel electrode PE.

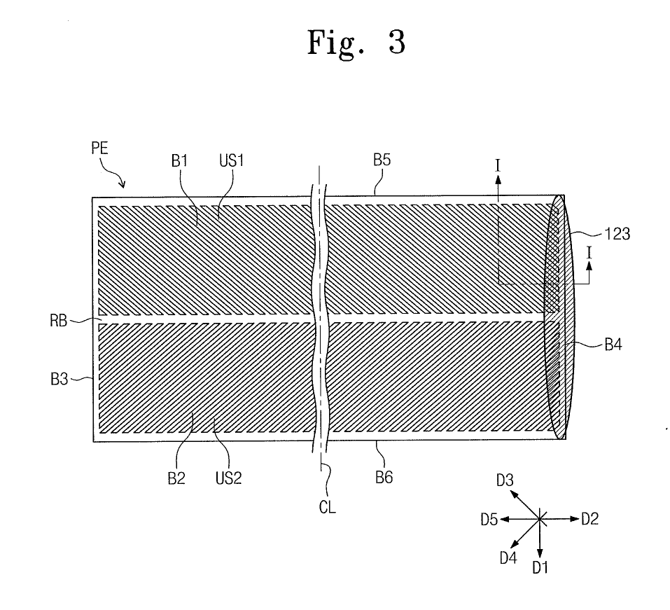

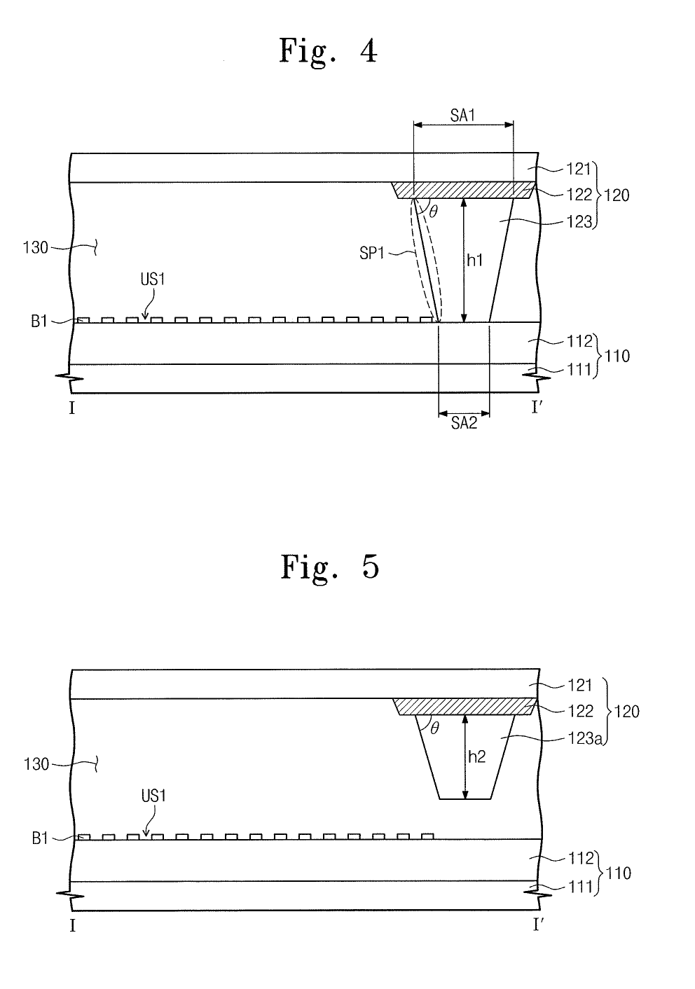

FIG. 3 illustrates a plan view showing a position relation between the pixel electrode PE and a spacer shown in FIG. 2. FIG. 4 illustrates a cross-sectional view taken along line I-I′ shown in FIG. 3.

Referring to FIG. 3, the pixel electrode PE includes the reference trunk portion RB that divides the pixels area into two areas to define the first and second domain areas DM1 and DM2. The reference trunk portion RB is extended in the second direction D2 to divide the pixel area into two areas arranged in the first direction D1. The pixel electrode PE further includes a plurality of first branch portions B1 extended from the reference trunk portion RB and arranged in the first domain area DM1 to be substantially in parallel to each other, and a plurality of second branch portions B2 extended from the reference trunk portion RB and arranged in the second domain area DM2 to be substantially in parallel to each other.

The first branches B1 are extended in the third direction D3 to be inclined with respect to the reference trunk portion RB, and the second branches B2 are extended in the fourth direction D4 to be inclined with respect to the reference trunk portion RB. Here, the third direction D3 is rotated at about 135 degrees in a clockwise direction with respect to the first direction D1, and the fourth direction D4 is rotated at about 45 degrees in the clockwise direction with respect to the first direction D1.

In the first domain area DM1, adjacent first branches B1 to each other are spaced apart from each other by a distance measured in terms of a micrometer to form, e.g., define, the first fine slits US1 therebetween, and in the second domain area DM2, adjacent second branches B2 to each other are spaced apart from each other by a distance measured in terms of a micrometer to form, e.g., define, the second fine slits US2 therebetween.

Referring to FIG. 4, the display panel 100 may include the first substrate 110, the second substrate 120 facing the first substrate 110, and a liquid crystal layer 130 disposed between the first substrate 110 and the second substrate 120. The first substrate 110 may include a first base substrate 111 and the pixel disposed on the first base substrate 111. In FIG. 4, other parts of the pixel have been omitted except for the pixel electrode PE, i.e., except for the first branches B1 of the pixel electrode PE, and an insulating layer 112 disposed under the pixel electrode PE. As an example, the insulating layer 112 may be a color filter layer including the color pixels.

The second substrate 120 may include a second base substrate 121, a black matrix 122, and a spacer 123. The black matrix 122 is formed of a light blocking material to block unnecessary light. The spacer 123 is disposed on the black matrix 122 to maintain a, e.g., constant, distance between the first base substrate 111 and the second base substrate 121. Although not shown in the figures, the second substrate 120 may further include a reference electrode. The reference electrode is disposed to face the pixel electrode PE and receives a common voltage to form an electric field in cooperation with the pixel electrode PE. In the case that the first and second fine slits US1 and US2 are formed in the pixel electrode PE, the reference electrode may be integrally formed as a single unitary and individual unit, e.g., to overlap all the pixel electrodes PE.

As shown in FIG. 3, the pixel electrode PE overlaps the spacer 123 when viewed in a plan view. A length of the spacer 123 extends in a first direction, i.e., the first direction D1, and is substantially vertical to the reference trunk portion RB.

The pixel electrode PE further includes first and second trunk portions B3 and B4 substantially in parallel to the first direction D1 and third and fourth trunk portions B5 and B6 substantially in parallel to the second direction D2. The first and second trunk portions B3 and B4 are respectively disposed at left and right sides with respect to the reference trunk portion RB, and the third and fourth trunk portions B5 and B6 are respectively disposed at upper and lower sides with respect to the reference trunk portion RB.

In the case that the first branches B1 are aligned in the third direction D3 and the second branches B2 are inclined in the fourth direction D4, a vector sum of the third direction D3 and the fourth direction D4 is defined by a fifth direction D5. Here, the fifth direction D5 is a direction opposite to the second direction D2.

As an example, the spacer 123 is located at a position, i.e., on the second direction D2, opposite to the fifth direction D5 with reference to an imaginary center line CL of the pixel electrode PE, which is substantially perpendicular to the reference trunk portion RB. For example, a width of the spacer 123 extends along the second direction D2. For example, the spacer 123 is disposed adjacent to and parallel to the first branches B1 located on the second direction D2 with reference to the center line CL, as illustrated in FIG. 4. In addition, the spacer 123 may overlap the first and second branches B1 and B2.

When viewed in a plan view, the spacer 123 may have an oval shape. In addition, as shown in FIG. 4, the spacer 123 has a column shape when viewed in a side or lateral direction, and a size of an upper surface of the spacer 123, i.e., a surface contacting the black matrix 122, is greater than that of a lower surface of the spacer 123, i.e., a surface contacting the insulating layer 112. For instance, a length SA1 in a short axis direction of the upper surface of the spacer 123 is longer than a length SA2 in a short axis direction of the lower surface of the spacer 123. Thus, the spacer 123 has a tapered shape on a sidewall thereof. As an example, a taper angle θ between the sidewall of the spacer 123 and the upper surface of the spacer 123 is in a range from about 40 degrees to about 90 degrees. When the taper angle θ of the spacer 123 is decreased, i.e., when a length of the lower surface of the spacer 123 is decreased, the overlap area between the spacer 123 and the pixel electrode PE is increased, i.e., a length of a horizontal portion of the pixel electrode PE corresponding to the inclined sidewall of the spacer 123 increases. On the contrary, when the taper angle θ of the spacer 123 is increased, the overlap area between the spacer 123 and the pixel electrode PE is decreased.

As an example, the spacer 123 has a height h1 of about 1.5 micrometers to about 2 micrometers. Due to the spacer 123, a step portion SP1 is formed, e.g., defined, between the first and second substrates 110 and 120. That is, when the second substrate 120 further includes an upper layer, e.g., an alignment layer, to cover the second base substrate 121 and the spacer 123, a step difference is defined in the upper layer in accordance with the step portion SP1 of the spacer 123. The step different occurring in the upper layer, which is caused by the spacer 123, may be in a range from about 1.5 micrometers to about 2 micrometers.

In FIG. 4, the lower surface of the spacer 123 is in direct contact with an uppermost layer of the first substrate 110, e.g., with the insulating layer 112, but embodiments are not limited thereto or thereby. That is, the lower surface of the spacer 123 may be disposed to be spaced apart from the uppermost layer of the first substrate 110 by a predetermined distance, as will be explained in more detail below with reference to FIG. 5.

FIG. 5 illustrates a cross-sectional view of a pixel according to another exemplary embodiment of the present disclosure.

As shown in FIG. 5, a lower surface of a spacer 123a is located at a position spaced apart from the uppermost layer of the first substrate 110 by a predetermined distance. In this case, the pixel electrode PE may overlap the lower surface of the spacer 123a.

In addition, when the lower surface of the spacer 123a is located at a position spaced apart from the uppermost layer of the first substrate 110 by the predetermined distance, a height h2 of the spacer 123a is smaller than the height h1. When the spacer 123a is disposed to be spaced apart from the first substrate 110, the second substrate 120 may further include a cell gap maintaining spacer (not shown) that makes contact with the first substrate 110 to maintain the distance between the first and second substrates 110 and 120.

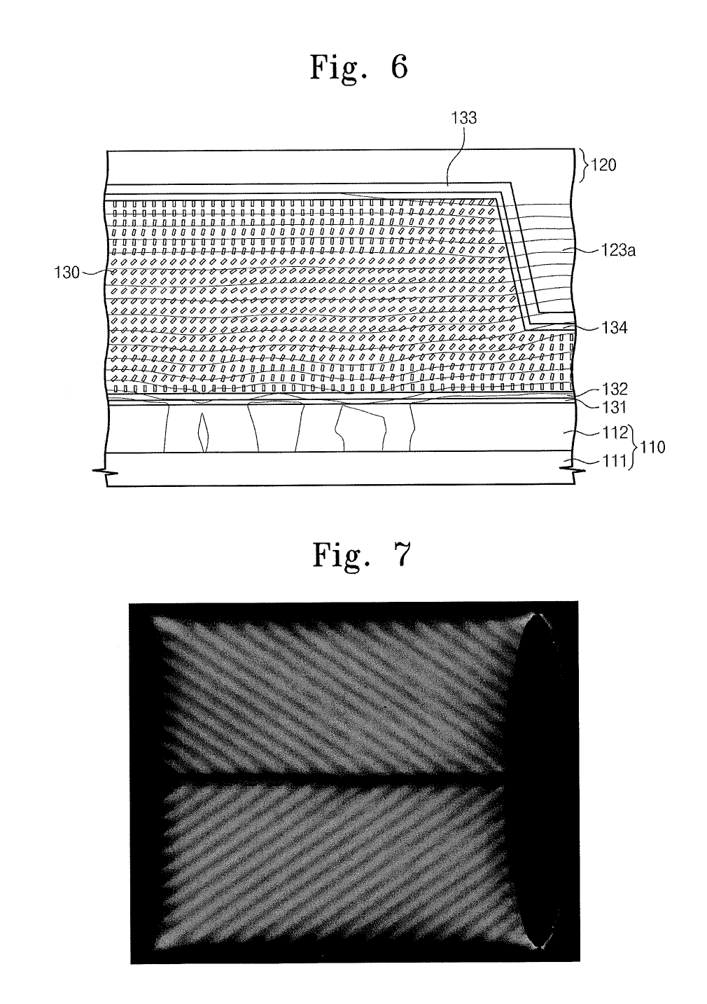

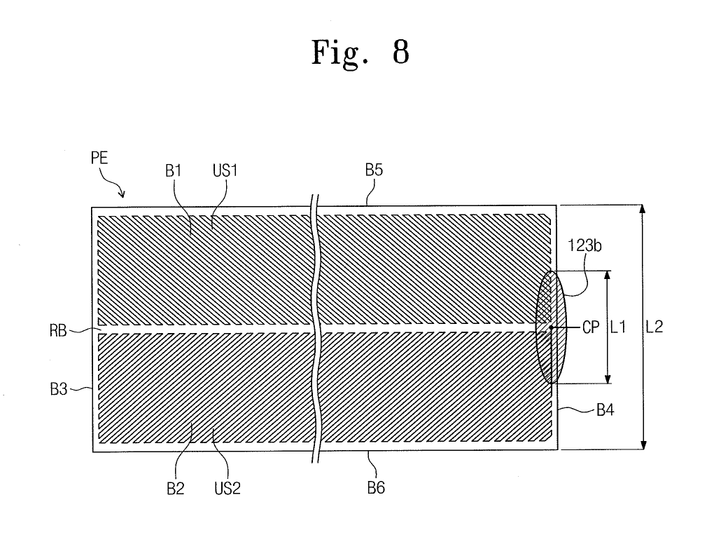

FIG. 6 illustrates a cross-sectional view of an alignment state of liquid crystal molecules in a sidewall portion of the spacer 123a. FIG. 7 illustrates a simulation result related of light transmittance when a pixel is driven.

Referring to FIG. 6, first and second alignment layers 131 and 133 may be coated on the first and second substrates 110 and 120, respectively, e.g., by using an inkjet or roll printing method. In addition, each of the first and second alignment layers 131 and 133 may be formed of materials applicable to a vertical alignment mode or a twisted nematic mode.

First and second light-curable layers 132 and 134 may be respectively disposed on the first and second alignment layers 131 and 133. The liquid crystal layer 130 is disposed between the first and second light-curable layers 132 and 134.

Hereinafter, a method of forming the first and second light-curable layers 132 and 134 will be described.

The liquid crystal layer 130 is formed between the first and second alignment layers 131 and 133. The liquid crystal layer 130 includes a mixture of liquid crystal molecules and a light-curing agent. The light-curing agent is present at a weight ratio of about 0.1 wt % or less with respect to the liquid crystal layer 130.

According to the present exemplary embodiment, the light-curing agent may be, but not limited to, a reactive mesogen RM. The term of “mesogen” used herein means a photocrosslinkable low molecular weight or a high molecular weight copolymer including a mesogen group of a liquid crystal property. Examples of suitable reactive mesogens are those including acrylate, methacrylate, epoxy, oxethane, vinyl-ether, styrene, or thiolene groups. In addition, the reactive mesogen RM may be a material in a bar shape, a banana shape, a board shape, or a disc shape.

Although not shown in the figures, the liquid crystal layer 130 may further include a photoinitiator. The photoinitiator is present at a weight ratio of about 0.01 wt % to about 1 wt % with respect to a total weight of the light-curing agent. The photoinitiator absorbs ultraviolet light with a long wavelength and is decomposed to form radicals, thereby accelerating a photo-polymerization reaction of the light-curing agent.

When an electric field is formed between the first substrate 110 and the second substrate 120, the liquid crystal molecules included in the liquid crystal layer 130 are aligned. Then, light, e.g., the ultraviolet light, is irradiated onto the liquid crystal layer 130 while the electric field is formed to perform an electric field exposure process. The light may be provided from one side or both sides of the first and second substrates 110 and 120.

When the light is irradiated onto the liquid crystal layer 130 while the electric field is formed, the liquid crystal molecules adjacent to the first and second alignment layers 131 and 133 are aligned to be substantially in parallel to the extension direction of the first and second fine slits US1 and US2 of the pixel electrode PE. In addition, the light-curing agent existing in the liquid crystal layer 130 is cured by the light irradiated thereon to have the same inclination angle as the liquid crystal molecules on the first and second alignment layers 131 and 133. Therefore, the first and second light-curable layers 132 and 134 are formed on the first and second alignment layers 131 and 133, respectively.

As shown in FIG. 6, the second alignment layer 133 and the second light-curable layer 134 may be sequentially stacked on the spacer 123a. The second alignment layer 133 and the second light-curable layer 134 may be, e.g., conformally, formed along the spacer 123a to cover, e.g., completely overlap, the sidewall and lower surface of the spacer 123a. That is, the second light-curable layer 134 may have the step portion SP1, which vertically or obliquely protrudes toward the first base substrate 111.

The liquid crystal molecules tend to be vertically aligned with respect to a surface of the second light-curable layer 134 in an area adjacent to the surface of the second light-curable layer 134. When the step portion SP1 is formed on the second light-curable layer 134, the liquid crystal molecules tend to align under the influence of the step portion SP1 in an area adjacent to a boundary between the spacer 123 and adjacent pixels.

In particular, in a conventional display apparatus, e.g., a display apparatus without the spacer 123, liquid crystal molecules may collide with each other at a boundary between adjacent pixels during alignment due to influence of an electric field in an adjacent pixel. Thus, a texture phenomenon may occur at an area adjacent to the boundary between conventional adjacent pixels. However, according to embodiments, the step portion SP1 of the spacer 123 reduces the influence of the electric field from an adjacent pixel, thereby facilitating proper alignment of liquid crystal molecules in each pixel.

As shown in FIG. 7, the liquid crystal molecules are aligned to be substantially in parallel to each other along the first and second fine slits US1 and US2, and thus the light transmits along the first and second fine slits US1 and US2. Particularly, the liquid crystal molecules are stably aligned in the area adjacent to the boundary of the pixels, i.e., in an area adjacent to the spacer 123, so the light transmits stably along the first and second fine slits US1 and US2. That is, when the step portion SP1 is formed in the spacer 123, the texture phenomenon may be prevented from occurring in the area adjacent to the boundary between the spacer 123 and the adjacent pixels.

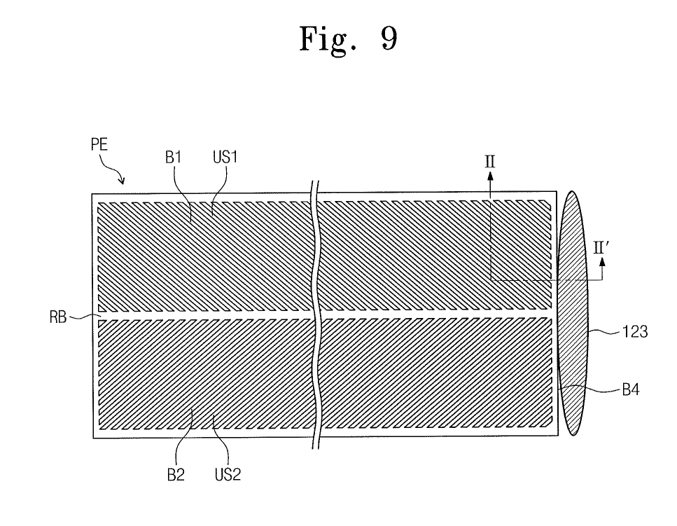

FIG. 8 illustrates a plan view showing a pixel and a spacer according to another exemplary embodiment of the present disclosure.

Referring to FIG. 8, a center point CP of a spacer 123b is located on the reference trunk portion RB or on the extension line of the reference trunk portion RB.

A length L1 in a long axis direction of the spacer 123b is smaller than a length L2 of the second trunk portion B4 of the pixel electrode PE and greater than a half (L2/2) of the length L2 of the second trunk portion B4. When the length L1 in the long axis direction of the spacer 123b is smaller than the half (L2/2) of the length L2 of the second trunk portion B4, the liquid crystal molecules are misaligned in an area adjacent to the second trunk portion B4, thereby causing texture defects. Thus, the length L1 in the long axis direction of the spacer 123b satisfies the following equation.

$$\frac{L 2}{2} < L 1 < L 2$$

That is, when the length L1 in the long axis direction of the spacer 123b is equal to or greater than the half (L2/2) of the length L2 of the second trunk portion B4, the texture defects may be improved.

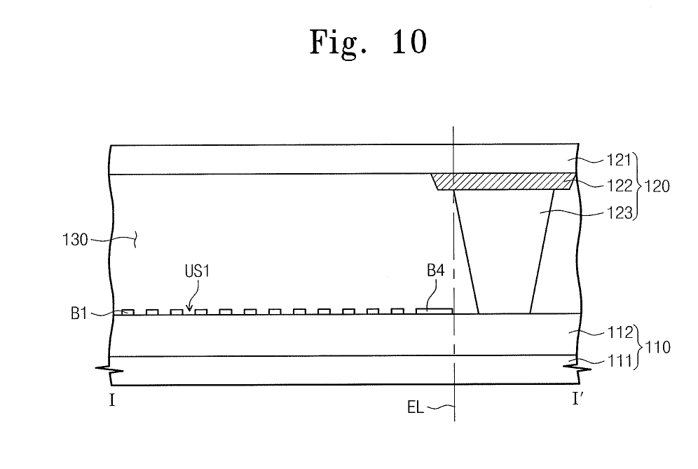

FIG. 9 illustrates a plan view showing a position relation between a spacer and a pixel according to another exemplary embodiment of the present disclosure. FIG. 10 illustrates a cross-sectional view taken along line II-II′ shown in FIG. 9.

Referring to FIGS. 9 and 10, the pixel electrode PE does not overlap the spacer 123 when viewed in a plan view. The second trunk portion B4 adjacent to the spacer 123 is located on an extension line EL extended from an end of the spacer 123 or positioned outside the extension line EL. Although the spacer 123 does not overlap the pixel electrode PE, the texture defects may be improved by the step portion SP 1 formed by the spacer 123.

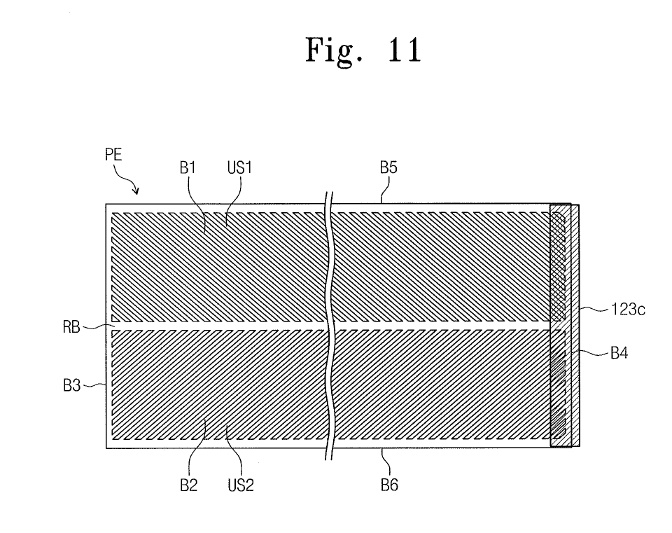

FIG. 11 illustrates a plan view showing a spacer according to another exemplary embodiment of the present disclosure.

Referring to FIG. 11, a spacer 123c has a rectangular shape when viewed in a plan view. The spacer 123c is extended along the second trunk portion B4 and has a uniform width along the longitudinal direction thereof. In addition, the spacer 123c overlaps the pixel electrode PE, but embodiments are not limited thereto or thereby, e.g., the spacer 123c may not overlap the pixel electrode PE as described above with reference to FIGS. 9-10.

The spacer 123c has a column shape with its upper and lower surfaces having a rectangular shape, and the width of the upper surface is equal to or greater than that of the lower surface. When the width of the upper surface is greater than that of the lower surface, the sidewall of the spacer 123c has the tapered shape and the taper angle of the sidewall of the spacer 123c is in a range from about 40 degrees to about 90 degrees. However, embodiments are not limited thereto or thereby, e.g., the spacer 123c may have different shapes than those shown in FIGS. 3, 9, and 11

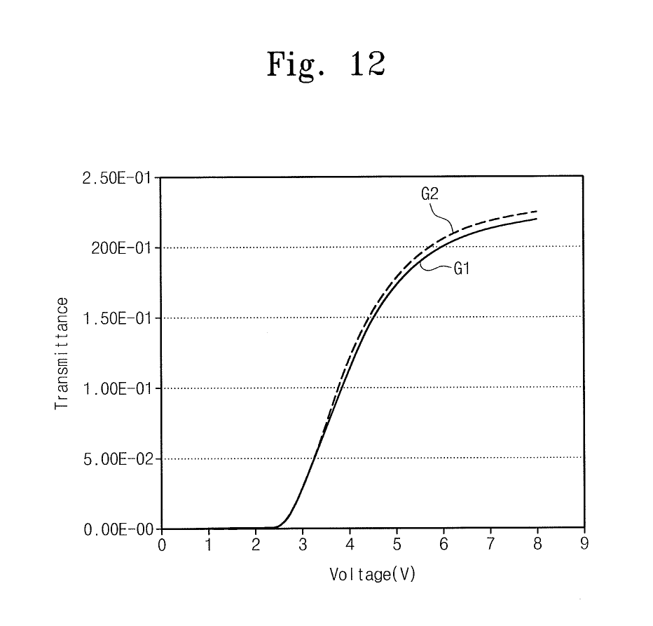

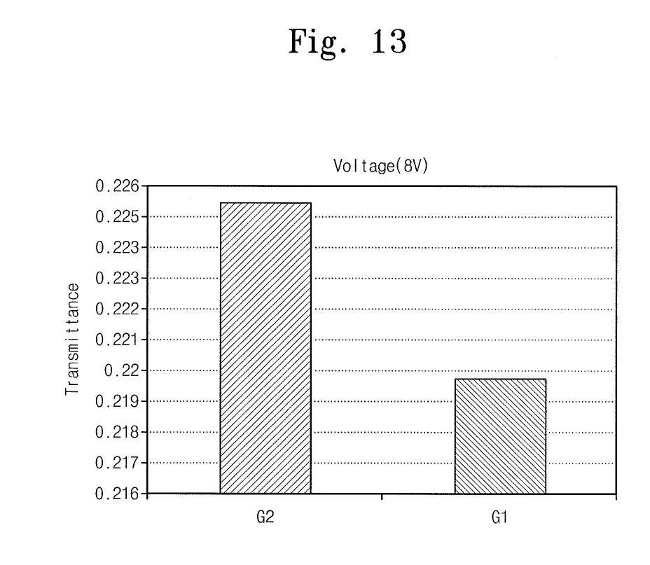

FIG. 12 illustrates a graph of transmittance of a pixel as a function of driving voltage, and FIG. 13 illustrates a graph showing the transmittance when the driving voltage is about 8 volts. In FIG. 12, an x-axis represents a driving voltage and a y-axis represents the transmittance. In addition, the first graph G1 in FIGS. 12 and 13 represents the transmittance of a four-domain structure, and the second graph G2 shown in FIGS. 12 and 13 represents the transmittance of a two-domain structure. Hereinafter, a structure of a pixel area divided into two domain areas will be referred to as a two-domain structure, and a structure of a pixel area divided into four domain areas will be referred to as a four-domain structure.

As shown in FIGS. 12 and 13, the transmittance in the two-domain structure is higher than the transmittance in the four-domain structure. As the driving voltage increases from about 2 volts to about 8 volts, the transmittance becomes higher. In order to divide the pixel area into the four domains, a vertical trunk portion that vertically crosses the reference trunk portion RB is required in addition to the reference trunk portion RB. Accordingly, an aperture ratio in the four-domain structure is lower than that of the two-domain structure by the area in which the vertical trunk portion is formed.

The two-domain structure is applied to products that require a high aperture ratio. When each pixel has the two-domain structure, the step portion SP1 of the spacer 123 is formed at a boundary area between adjacent pixel electrodes, i.e., an area in which a fringe field may be formed, and thus the texture defect may be improved. As a result, the aperture ratio may be improved and deterioration in product quality, which is caused by a texture defect, may be prevented.

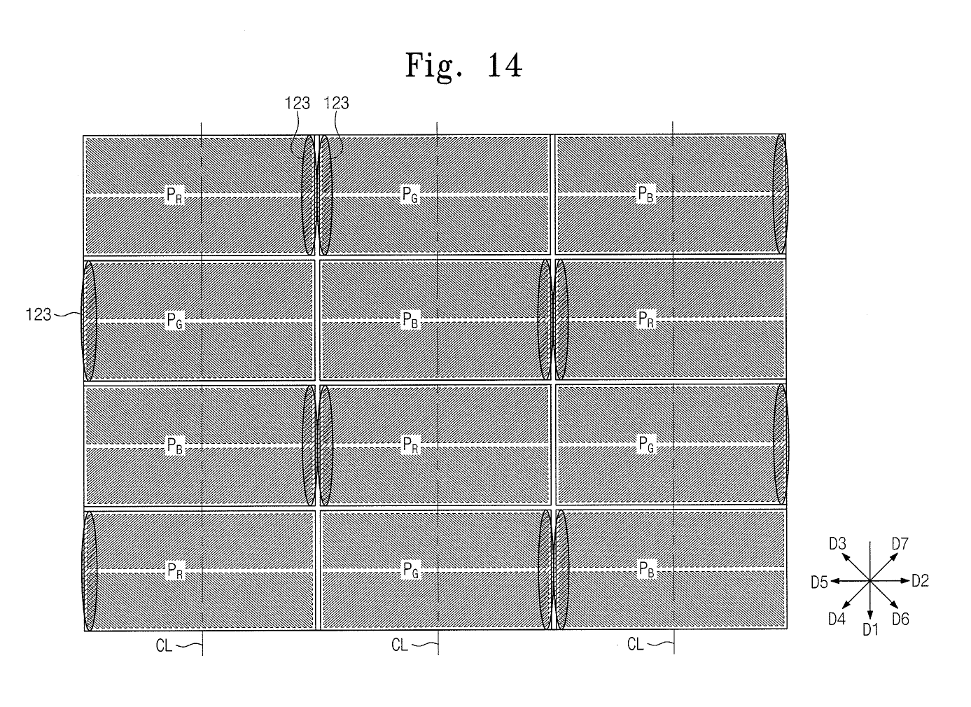

FIG. 14 illustrates a plan view showing a position relation between a spacer and pixels arranged in three columns by four rows according to an exemplary embodiment of the present disclosure.

Referring to FIG. 14, seven pixels are arranged in three columns by four rows. In a first pixel row, the red, green, and blue color pixels PR, PG, and PB are sequentially arranged. In a second pixel row, the green, blue, and red color pixels PG, PB, and PR are sequentially arranged, and the blue, red, and green color pixels PB, PR, and PG are sequentially arranged in a third pixel row. A fourth pixel row has the same structure as that of the first pixel row.

Each pixel includes the pixel electrode PE. The pixel electrode PE includes the first and second fine slits US1 and US2, which are symmetrical with each other with respect to the reference trunk portion RB. The direction in which the first and second fine slits US1 and US2 extend may be changed in the pixel unit. For instance, when the first and second fine slits US1 and US2 are respectively extended in the third and fourth directions D3 and D4 in n row by n column pixel, the first and second fine slits US1 and US2 are respectively extended in the seventh direction D7 opposite to the fourth direction D4 and the sixth direction D6 opposite to the third direction D3 in n row by (n+1) column pixel and (n+1) row by n column pixel, which are disposed to be adjacent to the n row by n column pixel. Here, “n” is an integer number equal to or greater than 1.

In the pixel arranged in the n row by n column, the spacer 123 is positioned in the second direction D2 opposite to the fifth direction D5 that is the vector sum of the third and fourth directions D3 and D4 with respect to the center line CL of the n row by n column pixel. In the pixel arranged in the n row by (n+1) column and the pixel arranged in the (n+1) row by n column, which are disposed to be adjacent to the n row by n column pixel, the spacer 123 is positioned in the fifth direction D5 opposite to the second direction D2 that is the vector sum of the sixth and seventh directions D6 and D7 with respect to the center line CL of the n row by (n+1) column pixel and the (n+1) row by n column pixel.

Thus, two spacers 123 are disposed between the n row by n column pixel and the n row by (n+1) column pixel and between (n+2) row by n column pixel and (n+2) row by (n+1) column pixel. However, the spacer 123 does not exist between (n+1) row by n column pixel and (n+1) row by (n+1) column pixel. That is, the spacer 123 is alternately arranged in left and right sides with respect to the center line CL in the first direction D1 and two spacers 123 are arranged in the second direction D2 every two pixels.

FIG. 15 illustrates a plan view showing a position relation between a spacer and pixels arranged in four columns by four rows according to another exemplary embodiment of the present disclosure.

Referring to FIG. 15, the spacer 123 is alternately arranged in left and right sides with respect to the center line CL in the first direction D1 and one spacer 123 is arranged in the second direction D2 every two pixels. That is, the n row by n column pixel shares one spacer 123 with the n row by (n+1) column pixel. When the one spacer 123 is referred to as a common spacer, the common spacer 123 may be overlapped with the n row by n column pixel and the n row by (n+1) column pixel. The common spacer 123 is alternately arranged in left and right sides with respect to the center line CL in the first direction D1.

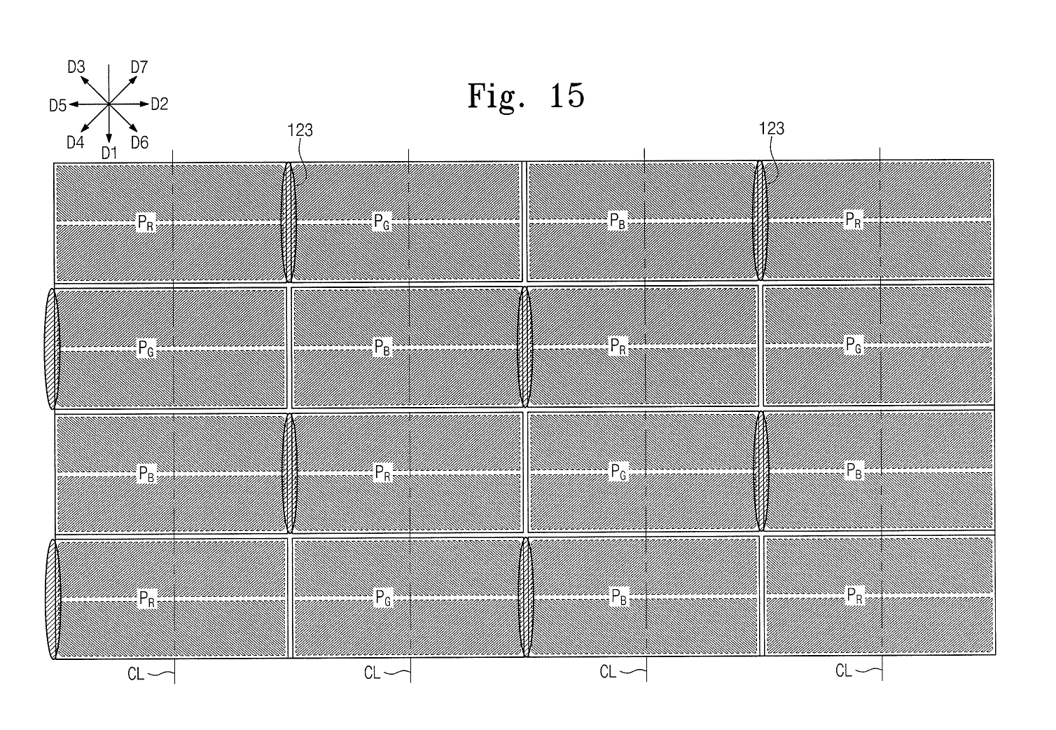

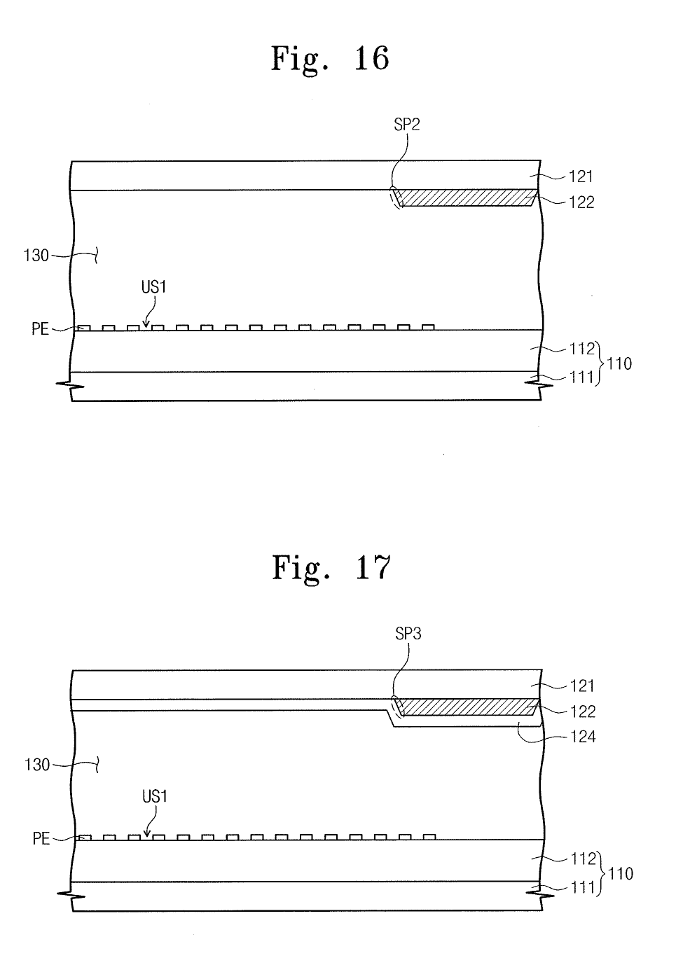

FIG. 16 illustrates a cross-sectional view showing a pixel according to another exemplary embodiment of the present disclosure.

Referring to FIG. 16, a step portion SP2 is formed in the pixel PX by the black matrix 122. As an example, the black matrix 122 has a thickness of about 0.8 micrometers to about 0.9 micrometers and a sidewall of the black matrix 122 has a tapered shape. The taper angle of the sidewall of the black matrix 122 is in a range of about 40 degrees to about 90 degrees.

In addition, the black matrix 122 overlaps the pixel electrode PE. In particular, since the height of the step portion SP2 provided by the black matrix 122 is smaller than the height of the step portion SP1 provided by the spacer 123, the overlap area between the black matrix 122 and the pixel electrode PE becomes greater than the overlap area between the spacer 123 and the pixel electrode PE when the step portion SP2 is formed by using the black matrix 122.

FIG. 17 illustrates a cross-sectional view showing a pixel according to another exemplary embodiment of the present disclosure.

Referring to FIG. 17, a step portion SP3 is formed in the pixel PX by the black matrix 122 and an overcoating layer 124 covering the black matrix 122. Since the step portion SP3 exists on the overcoating layer 124 by a step difference between the black matrix 122 and the second base substrate 121, a height of the step portion SP3 is equal to or smaller than the height of the black matrix 122. The height of the step portion SP3 is smaller than the height of the step portion SP1 provided by the spacer 123, and thus the overlap area between the black matrix 122 and the pixel electrode PE becomes greater than the overlap area between the spacer 123 and the pixel electrode PE.

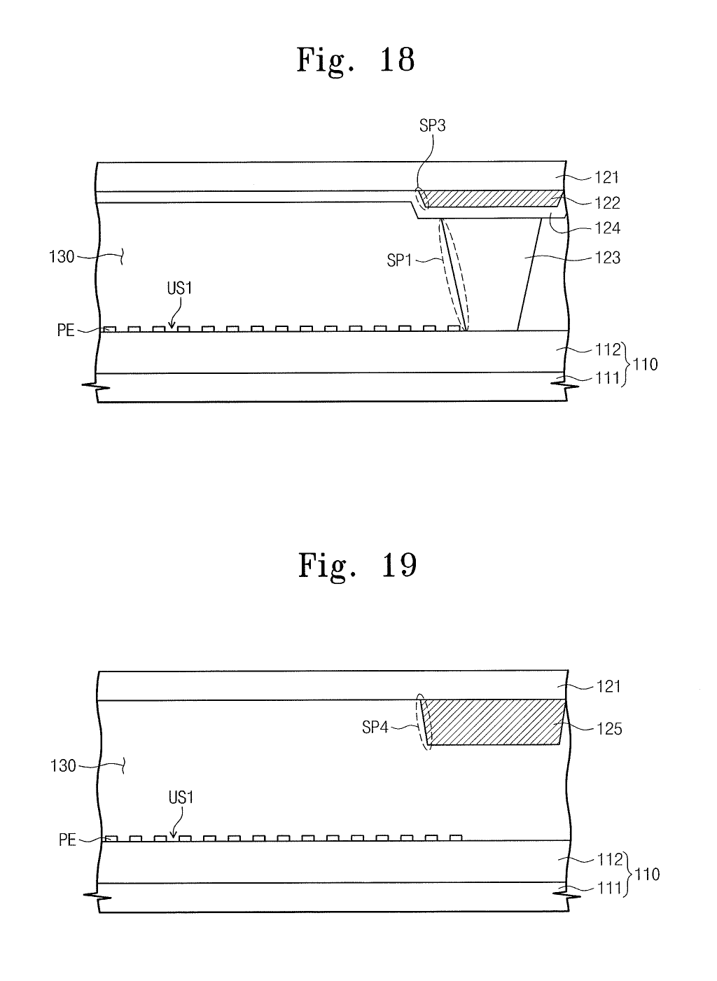

FIG. 18 illustrates a cross-sectional view showing a pixel according to another exemplary embodiment of the present disclosure.

Referring to FIG. 18, the step portion SP3 is formed in the pixel PX by the black matrix 122 and the overcoating layer 124 covering the black matrix 122 and the step portion SP1 is formed in the pixel PX by the spacer 123 disposed on the overcoating layer 124. That is, the pixel PX has a double step difference structure.

Since the step portion SP3 exists on the overcoating layer 124 by the step difference between the black matrix 122 and the second base substrate 121, the height of the step portion SP3 is equal to or smaller than the height of the black matrix 122. The step portion SP1 is provided by the step difference between the spacer 123 and the overcoating layer 124. Since the double step difference structure is provided in the boundary area in which the fringe field is formed between the pixel electrode of each pixel and adjacent pixel electrode, the texture defect may be effectively improved.

FIG. 19 illustrates a cross-sectional view showing a pixel according to another exemplary embodiment of the present disclosure.

Referring to FIG. 19, a thickness of the black matrix 122 increases in the boundary area in which the fringe field is formed between a pixel electrode of each pixel and an adjacent pixel electrode, so that a step portion SP4 having a thickness greater than that of the step portion SP2 is formed in the pixel PX. The thickness of the black matrix 122 may be controlled in the process of manufacturing the black matrix 122, and thus the thickness of the black matrix 122 may be increased in the boundary area in which the fringe field is formed.

By way of summary and review, when a common electrode of a conventional liquid crystal display is patterned and the liquid crystal domains are formed in the liquid crystal display, the number of processes during manufacturing of the liquid crystal display increases. In addition, a misalignment occurs between the two substrates of the liquid crystal display, where the liquid crystal domains are not normally formed. Further, in a conventional pixel, e.g., having a two-domain structure, a texture defect may occur in the pixel, e.g., caused by a fringe field between adjacent pixels.

In contrast, according to embodiments, the liquid crystal display includes a spacer in a boundary area between adjacent pixels, i.e., a structure protruding from the second base substrate toward the first base substrate in the boundary area between adjacent pixels. Therefore, even if a fringe field occurs at the boundary between adjacent pixels, alignment of the liquid crystal molecules at the boundary is controlled by the step portion of the spacer. Thus, a texture defect, which may be caused by the fringe field, may be prevented from occurring, e.g., in a two-domain structure.

Although exemplary embodiments have been described, it is understood that the embodiments should not be limited to those described herein but various changes and modifications can be made by one ordinary skilled in the art. Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A display apparatus, comprising:
a first substrate including a first base substrate and pixel electrodes on the first base substrate, the pixel electrodes including a plurality of fine slits;
a second substrate including a second base substrate facing the first base substrate and a reference electrode, the second base substrate being coupled to the first base substrate;
a structure part including a step portion and extending from the second base substrate toward the first base substrate, the structure part being in a boundary area between two adjacent pixel electrodes and being configured to block a fringe field in the boundary area; and
a liquid crystal layer between the pixel electrodes and the reference electrode and including liquid crystal molecules, an alignment of the liquid crystal molecules in an area adjacent to the structure part being controlled by the step portion of the structure part.

2. The display apparatus as claimed in claim 1, wherein each pixel electrode includes a reference trunk portion dividing the pixel electrode into a first domain area and a second domain area.

3. The display apparatus as claimed in claim 2, wherein the fine slits in each pixel electrode include:
first fine slits in the first domain area, the first fine slits being inclined in a first direction with respect to the reference trunk; and
second fine slits in the second domain area, the second fine slits being inclined in a second direction with respect to the reference trunk portion, the second fine slits being symmetrical with the first fine slits with respect to the reference trunk portions.

4. The display apparatus as claimed in claim 3, wherein the structure part has a length in a direction substantially perpendicular to the reference trunk portion, and has a width in a direction opposite to a vector sum of the first and second directions with respect to a center line of the pixel electrode.

5. The display apparatus as claimed in claim 3, wherein, when the first and second fine slits are respectively extended in the first and second directions in the pixel arranged in n row by n column (n is natural number equal to or greater than 1), the first and second fine slits are respectively extended in a third direction opposite to the second direction and a fourth direction opposite to the first direction in the pixel arranged in n row by (n+1) column and the pixel arranged in (n+1) row by n column.

6. The display apparatus as claimed in claim 5, wherein the structure part is alternately disposed at left and right sides along a column direction with respect to the center line of the pixel electrode and disposed in a row direction every two pixels.

7. The display apparatus as claimed in claim 1, wherein the structure part partially overlaps the pixel electrode when viewed in a plan view.

8. The display apparatus as claimed in claim 1, wherein the structure part has an oval shape or a rectangular shape when viewed in a plan view.

9. The display apparatus as claimed in claim 1, wherein the structure part includes a spacer, the spacer being configured to maintain a constant distance between the first base substrate and the second base substrate.

10. The display apparatus as claimed in claim 9, wherein the spacer has a height from about 1.5 micrometers to about 2.5 micrometers.

11. The display apparatus as claimed in claim 9, wherein a sidewall of the spacer is tapered at an angle from about 40 degrees to about 90 degrees, the angle being defined relative to a surface of the second base substrate.

12. The display apparatus as claimed in claim 9, wherein the spacer partially overlaps the pixel electrode when viewed in a plan view.

13. The display apparatus as claimed in claim 9, wherein the structure part further comprises a black matrix between the spacer and the second base substrate, the black matrix including a light blocking material.

14. The display apparatus as claimed in claim 13, wherein the black matrix has a thickness of about 0.9 micrometers to about 1.5 micrometers.

15. The display apparatus as claimed in claim 14, wherein a sidewall of the black matrix is tapered at an angle from about 40 degrees to about 90 degrees, the angle being defined relative to a surface of the second base substrate.

16. The display apparatus as claimed in claim 13, wherein the black matrix partially overlaps the pixel electrode when viewed in a plan view.

17. The display apparatus as claimed in claim 13, wherein the structure part further comprises an overcoating layer between the black matrix and the spacer.

18. The display apparatus as claimed in claim 1, wherein the structure part further comprises a black matrix disposed on the second base substrate, the black matrix including a light blocking material.

19. The display apparatus as claimed in claim 1, further comprising:
a first alignment layer on the first substrate; and
a second alignment layer on the second substrate and face the first alignment layer, the liquid crystal layer being between the first and second alignment layers.

20. The display apparatus as claimed in claim 19, further comprising:
a first light-curable layer on the first alignment layer, the first light-curable layer being configured to pre-tilt liquid crystal molecules adjacent to the pixel electrode; and
a second light-curable layer on the second alignment layer, the second light-curable layer being configured to pre-tilt liquid crystal molecules adjacent to the reference electrode.
